(19) United States
(12) Patent Application Publication
(10) Pub. No.: US 2022/0129955 A1
(43) Pub. Date: Apr. 28, 2022

(54) Systems and Methods for Charitable Giving

(71) Applicant: Zackery Craig Mateer, Orlando, FL (US)

(72) Inventor: Zackery Craig Mateer, Orlando, FL (US)

(21) Appl. No.: 17/570,782

(22) Filed: Jan. 7, 2022

Related U.S. Application Data
(63) Continuation of application No. 16/655,625, filed on Oct. 17, 2019.
(60) Provisional application No. 62/747,312, filed on Oct. 18, 2018.

(51) Int. Cl. G06Q 30/02; G06Q 20/10

(52) U.S. Cl. CPC G06Q 30/0279; G06Q 20/108; G06Q 30/0201

(57) ABSTRACT

A system for charitable giving comprising a first device configured for displaying a charitable donation registry to a donor and enabling the donor to initiate a transfer of a gift from the charitable donation registry to a recipient; and a second device configured for enabling the recipient to define the gift on the charitable donation registry and enabling the recipient to initiate a request for the transfer of the gift.

### CROSS REFERENCE TO RELATED APPLICATIONS

This is a continuation of U.S. patent application Ser. No. 16/655,625, filed Oct. 17, 2019, which claims the benefit of, and priority to, U.S. Provisional Patent Application Ser. No. 62/747,312, filed Oct. 18, 2018. The entire contents of these prior Applications are incorporated by reference herein.

### FIELD OF THE INVENTION

The present invention generally relates to systems and methods for charitable giving, and more particularly, to systems and methods aimed at fulfilling the specific needs of a person seeking charitable support.

### BACKGROUND

Many existing systems for charitable giving enable a donor to submit money or other types of donations, such as food, clothing, and other supplies, to a general collection pool managed by a charitable organization. The contents of the collection pool are subsequently distributed by the charitable organization to people in need. The identity of the recipient of the donated funds, therefore, is typically unknown to the donor. Moreover, the goods provided are often not tailored to the specific needs of the recipient. As a result, a particular recipient's specific needs often go unfulfilled.

While systems exist for providing support to a particular individual, such as, for example, web-based services like GoFundMe® and Kickstarter®, these services are primarily limited to providing financial support.

Thus, there remains a need in the art for individual recipients seeking charitable support to identify their specific needs, and for donors to identify those recipients and provide donations to fulfill the specific needs. The embodiments disclosed herein are aimed at overcoming these and other limitations in the art.

### BRIEF DESCRIPTION OF THE DRAWINGS

Embodiments of the invention are described by way of example with reference to the accompanying drawings in which:

FIG. 1 depicts a first exemplary system in accordance with an embodiment of the present disclosure; and

FIG. 2 depicts a second exemplary system in accordance with an embodiment of the present disclosure.

### DETAILED DESCRIPTION OF THE PREFERRED EMBODIMENTS

The present invention will now be described more fully hereinafter with reference to the accompanying drawings, in which embodiments of the invention are shown by way of illustration and example. This invention may, however, be embodied in many forms and should not be construed as limited to the embodiments set forth herein. Rather, these embodiments are provided so that this disclosure will be thorough and complete, and will fully convey the scope of the invention to those skilled in the art. Like numerals refer to like elements.

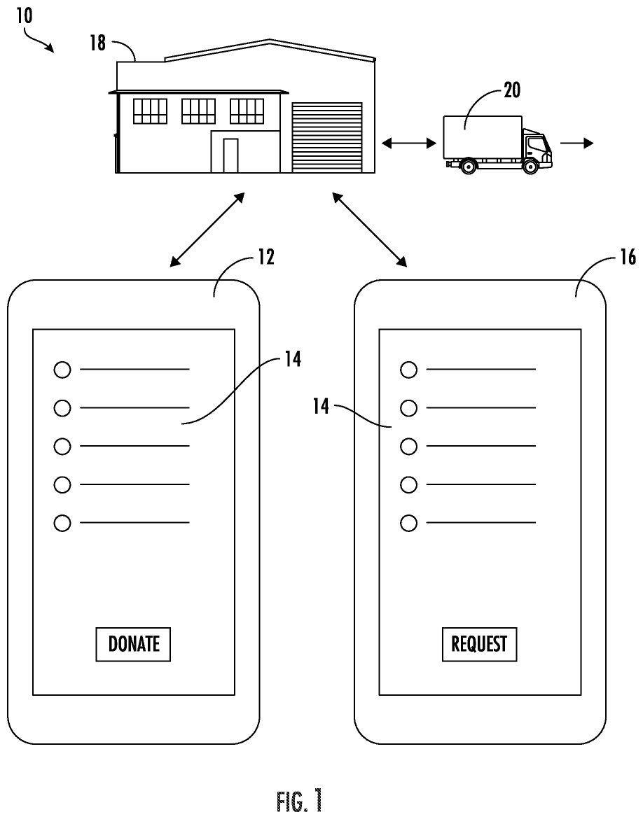

With reference initially to FIG. 1, one embodiment of the present disclosure includes a system 10 for charitable giving. The system 10 comprises a first device 12 configured for displaying a charitable donation registry 14 to a donor. The charitable donation registry 14 depicts or lists a series of specific gifts available for donation. The first device 12 enables the donor to initiate a transfer of a gift listed in the charitable donation registry 14 to a recipient. The first device 12 may also be configured for searching for and identifying a desired recipient.

In one embodiment, a second device 16 is configured for enabling the recipient to define the gift on the charitable donation registry 14, and may be further configured for enabling the recipient to initiate a request for the transfer of the gift. For instance, if a recipient is in need of a bus pass to get to and from work, the recipient may identify a bus pass on their charitable gift registry in connection with the recipient's personal profile created within the system. A donor may then provide the funds needed to pay for the bus pass via the system or otherwise. In one embodiment, the funds are transferred to a third party, which then purchases and provides the bus pass (or other gift) to the recipient. Alternatively, the system may engage the support of a local municipal transportation system (i.e. a vendor), which may function as the third-party intermediary between the donor and the recipient. In light of this example, it will be appreciated by one of ordinary skill in the art that any other suitable third-party vendor may engage the system. In one embodiment, at least one of the first device and the second device may be configured for defining a pick up or drop off location for the gift, as well as a time for transfer of the gift to the recipient.

The first and second devices may be any suitable device for carrying out the functions of the present disclosure, such as a smart phone, a computer, a tablet, a smart watch, or the like. Alternatively, the functional aspects of the system's first and/or second devices of the present disclosure may be housed in a publicly-available kiosk, thereby making the system available to homeless populations, for example, that lack computer and/or internet access.

Another component of the system may include a clearinghouse 18 in communication with at least one of the first device 12 and the second device 16, said clearinghouse configured for providing the gift to the recipient upon the donor's initiation of the transfer of the gift. The clearinghouse may be a third-party vendor or other suitable intermediary between the donor and the recipient. In one embodiment, the gift is in possession of the clearinghouse. In another embodiment, the clearinghouse simply facilitates the transaction between the donor and the recipient.

The system 10 may also include any suitable means for delivering the gift to the recipient, such as a transporter 20 configured for transporting the gift from the clearinghouse to the recipient. The transporter may comprise a common carrier, delivery service, mail service, drone, or any other suitable delivery means.

In order for a donor to select a particular type of recipient, first device 12 may be configured for enabling the donor to select the recipient based upon at least one characteristic of the recipient. For example, the characteristic may comprise at least one of age, gender, location, educational status, socioeconomic status, annual income, victim status, hardship status, and health status of the recipient. Therefore, and by way of non-limiting example, an individual donor seeking to support a recipient's educational endeavors may select a recipient based on the recipient's specific identified characteristic and provide support to that particular individual based on a specific need defined by a recipient, such as a backpack for carrying books or a ride share subscription for the recipient to obtain transportation to and from school.

Likewise, the second device 16 may be configured for enabling the recipient to input at least one characteristic about themselves. For example, the characteristic may comprise at least one of age, gender, location, educational status, socioeconomic status, annual income, victim status, hardship status, and health status.

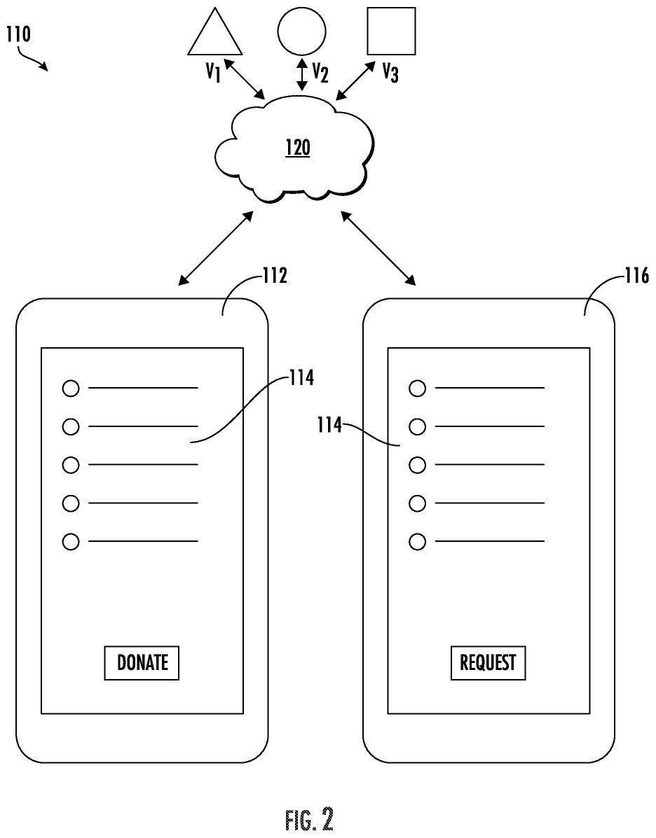

As depicted in FIG. 2, another embodiment of the present disclosure includes a system 110 for charitable giving, the system comprising a first device 112 configured for displaying the contents of a charitable donation registry 114 to a donor, said first device 112 further configured for enabling the donor to initiate a transfer of a gift from the charitable donation registry 114 to a recipient.

Also envisioned as a component of the system 110 is a second device 116 configured for enabling the recipient to define the gift to be included on the charitable donation registry 114, said second device 116 further configured for enabling the recipient to initiate a request for the transfer of the gift.

The first device 112 may be configured for enabling the donor to select the recipient based upon at least one characteristic of the recipient, wherein said characteristic comprises at least one of age, gender, location, educational status, socioeconomic status, annual income, victim status, hardship status, and health status.

Likewise, the second device 116 may be configured for enabling the recipient to input at least one characteristic of the recipient, wherein the characteristic comprises at least one of age, gender, location, educational status, socioeconomic status, annual income, victim status, hardship status, and health status.

The first 112 and second 116 devices may communicate via the internet to a third-party intermediary 120 between the donor and the recipient. The intermediary may also communicate with vendors V1, V2, V3 sufficient for supplying a gift identified by the recipient. The gift may be sent to the recipient by the intermediary 120 or, alternatively, sent directly to the recipient by the vendor. Thus, it is envisioned that in some embodiments of the present disclosure, no money is transferred from the donor to the recipient. Embodiments involving the direct transfer of money from the donor to the recipient, however, and considered to be within the scope of the present disclosure.

Yet another embodiment of the present disclosure includes a method for charitable giving, the method comprising providing a software application operable with a device, said software application configured for displaying a charitable donation registry to a donor via the device, said software application further configured for enabling the donor to initiate a transfer of a gift from the charitable donation registry to a recipient. The software application may be further configured for enabling the recipient to define the gift on the charitable donation registry and initiate a request for the transfer of the gift. As will be apparent to one of ordinary skill in the art, the software application may be operable with a smart phone, a smart watch, a computer, tablet, or other suitable device capable of running the software application.

The software application may be configured for enabling the donor to select the recipient based upon at least one characteristic of the recipient, wherein the characteristic comprises at least one of age, gender, location, educational status, socioeconomic status, annual income, victim status, hardship status, and health status. Likewise, the software application may be configured for enabling the recipient to input at least one characteristic of the recipient, wherein the characteristic comprises at least one of age, gender, location, educational status, socioeconomic status, annual income, victim status, hardship status, and health status.

Although the invention has been described relative to various selected embodiments herein presented by way of example, there are numerous variations and modifications that will be readily apparent to those skilled in the art in light of the above teachings. It is therefore to be understood that, within the scope of the claims hereto attached and supported by this specification, the invention may be practiced other than as specifically described.

What is claimed is:

1. A system for charitable giving, the system comprising:
a first device configured for displaying a charitable donation registry to a donor, said first device further configured for enabling the donor to initiate a transfer of a gift from the charitable donation registry to a recipient;
a second device configured for enabling the recipient to define the gift on the charitable donation registry, said second device further configured for enabling the recipient to initiate a request for the transfer of the gift; and
a clearinghouse in communication with at least one of the first device and the second device, said clearinghouse configured for providing the gift to the recipient upon the donor's initiation of the transfer of the gift.

2. The system of claim 1, further comprising a transporter configured for transporting the gift from the clearinghouse to the recipient.

3. The system of claim 1, wherein the first device is configured for enabling the donor to select the recipient based upon at least one characteristic of the recipient.

4. The system of claim 3, wherein said characteristic comprises at least one of age, gender, location, educational status, socioeconomic status, annual income, victim status, hardship status, and health status.

5. The system of claim 1, wherein the second device is configured for enabling the recipient to input at least one characteristic of the recipient.

6. The system of claim 5, wherein the characteristic comprises at least one of age, gender, location, educational status, socioeconomic status, annual income, victim status, hardship status, and health status.

7. A system for charitable giving, the system comprising:
a first device configured for displaying a charitable donation registry to a donor, said first device further configured for enabling the donor to initiate a transfer of a gift from the charitable donation registry to a recipient; and
a second device configured for enabling the recipient to define the gift on the charitable donation registry, said second device further configured for enabling the recipient to initiate a request for the transfer of the gift.

8. The system of claim 7, wherein the first device is configured for enabling the donor to select the recipient based upon at least one characteristic of the recipient.

9. The system of claim 8, wherein said characteristic comprises at least one of age, gender, location, educational status, socioeconomic status, annual income, victim status, hardship status, and health status.

10. The system of claim 7, wherein the second device is configured for enabling the recipient to input at least one characteristic of the recipient.

11. The system of claim 10, wherein the characteristic comprises at least one of age, gender, location, educational status, socioeconomic status, annual income, victim status, hardship status, and health status.

12. A method for charitable giving, the method comprising:
providing a software application operable with a device, said software application configured for displaying a charitable donation registry to a donor via the device, said software application further configured for enabling the donor to initiate a transfer of a gift from the charitable donation registry to a recipient.

13. The method of claim 12, wherein said software application is configured for enabling the donor to select the recipient based upon at least one characteristic of the recipient.

14. The method of claim 13, wherein the characteristic comprises at least one of age, gender, location, educational status, socioeconomic status, annual income, victim status, hardship status, and health status.

15. The method of claim 12, wherein the software application is further configured for enabling the recipient to define the gift on the charitable donation registry and initiate a request for the transfer of the gift.

16. The method of claim 15, wherein the software application is configured for enabling the recipient to input at least one characteristic of the recipient.

17. The method of claim 16, wherein the characteristic comprises at least one of age, gender, location, educational status, socioeconomic status, annual income, victim status, hardship status, and health status.
